(19) United States
(12) Patent Application Publication
(10) Pub. No.: US 2006/0266151 A1
(43) Pub. Date: Nov. 30, 2006

(54) POWER ADJUST TILT-TELESCOPE STEERING COLUMN

(75) Inventors: Wayne M. Avers, Northville, MI (US); William Korzan, Canton, MI (US); Thomas E. Lamb, Dexter, MI (US); Daniel G. McCluskey, Harrison Township, MI (US); Steven Waldie, Brighton, MI (US)

Correspondence Address: SACHNOFF & WEAVER, LTD., 10 SOUTH WACKER DRIVE, CHICAGO, IL, 60606-7507, US

(73) Assignee: Admiral Tool And Manufacturing Company, Inc., Livonia, MI (US)

(21) Appl. No.: 11/420,179

(22) Filed: May 24, 2006

Related U.S. Application Data
(60) Provisional application No. 60/684,629, filed on May 25, 2005.

(51) Int. Cl. B62D 1/16

(52) U.S. Cl. 74/492

(57) ABSTRACT

A steering column apparatus disclosed herein includes an inner-outer cylinder assembly housing a steering shaft, an outer jacket, an anchorage and a compression bracket, wherein the outer jacket, the anchorage and the compression-bracket are coupled together via a cross-bolt. The apparatus is further attached to a locking motor adapted to secure the steering column apparatus in a tilt-telescope position, a tilt-motor adapted to tilt the steering shaft along a pivotal axis, and a telescopic-motor adapted to move the steering shaft along a telescopic axis. Each of the locking motor, the tilt-motor and the telescopic motor may be adapted to be actuated using a switch or a memory device.

### CROSS-REFERENCE TO RELATED APPLICATIONS

This application is based on and claims the benefit of U.S. Provisional Application No. 60/684,629, filed on Mar. 25, 2005 and entitled “Power Adjust Tilt-Telescope Steering Column,” which is incorporated herein by reference in its entirety.

### FIELD

This patent relates to a tilt-telescope steering column for use in an automobile.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings, of which:

FIG. 1 illustrates a tilt-telescope steering column formed in accordance with the teachings of the present invention wherein the column is shown telescoped and tilted in the nominal positions;

FIG. 2 shows a right side view of the steering column of FIG. 1, wherein the column is shown telescoped in the full out position and tilted in the nominal position;

FIG. 3 shows a right side view of the steering column of FIG. 1, wherein the column is shown telescoped in the full in position and tilted in the nominal position;

FIG. 4 shows a right side view of the steering column of FIG. 1, wherein the column is shown telescoped in the nominal position and tilted to the full down position;

FIG. 5 shows a right side view of the steering column of FIG. 1, wherein the column is shown telescoped in the nominal position and tilted to the full up position;

FIG. 6 shows a left side view of the steering column of FIG. 1, wherein the column is shown telescoped and tilted in the nominal positions;

FIG. 7 shows a left side view of the steering column of FIG. 1, wherein the column is shown telescoped to the full in position and tilted in the nominal position;

FIG. 8 shows a left side view of the steering column of FIG. 1, wherein the column is shown telescoped to the full out position and tilted to the nominal position;

FIG. 9 shows a left side view of the steering column of FIG. 1, wherein the column is shown telescoped in the nominal position and tilted in the full down position;

FIG. 10 shows a left side view of the steering column of FIG. 1, wherein the column is shown telescoped in the nominal position and tilted to the full up position;

FIG. 11 shows a bottom view of the steering column of FIG. 1, wherein the column is shown telescoped in the full in position and tilted in the nominal position;

FIG. 12 shows a bottom view of the steering column of FIG. 1, wherein the steering column is exposed; and

FIG. 13 is a section view of the steering column shown in FIG. 1, showing the relationship between the internal structure of the steering column and what is viewable externally.

### DETAILED DESCRIPTION

A steering column apparatus disclosed herein includes an inner-outer cylinder assembly housing a steering shaft, an outer jacket, an anchorage and a compression bracket, wherein the outer jacket, the anchorage and the compression-bracket are coupled together via a cross-bolt. The apparatus is further attached to a locking motor adapted to secure the steering column apparatus in a tilt-telescope position, a tilt-motor adapted to tilt the steering shaft along a pivotal axis, and a telescopic-motor adapted to move the steering shaft along a telescopic axis. Each of the locking motor, the tilt-motor and the telescopic motor may be adapted to be actuated using a switch or a memory device. For example, a memory device attached to the steering column 10 may generate a signal based on a computer code stored on the memory, wherein such computer code may analyze a number of different signals received from users or from various components of an automobile housing the steering column 10.

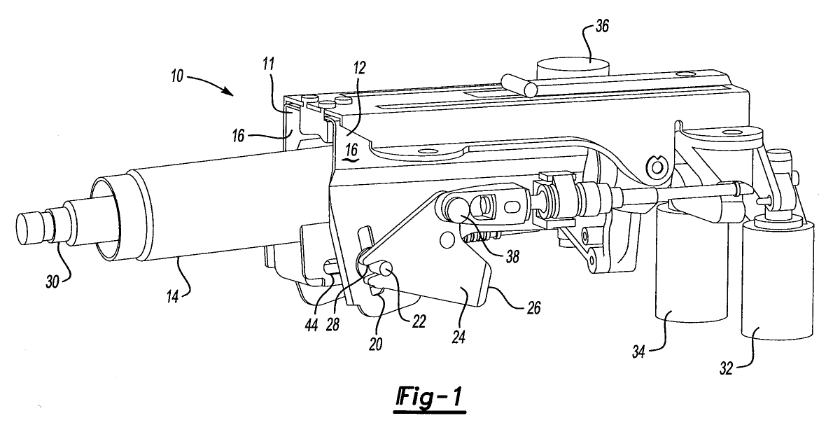

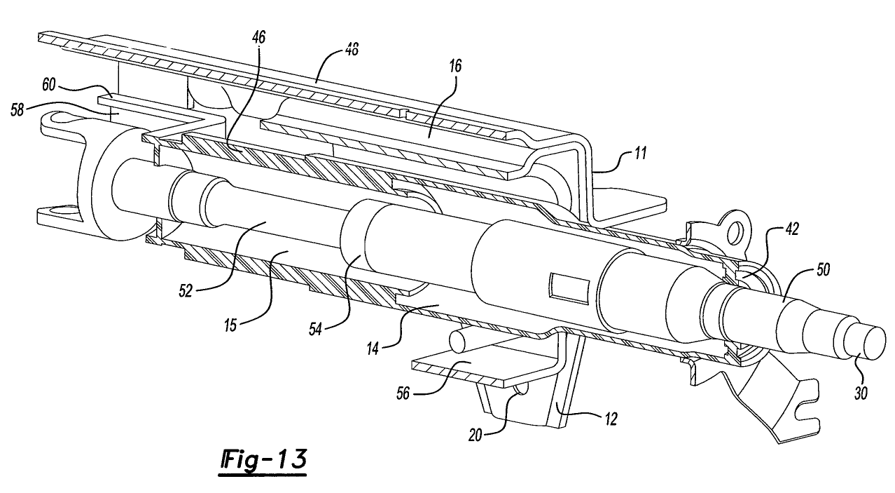

The following description of the embodiments is merely exemplary in nature and is in no way intended to limit the scope, application, or uses of the embodiments. Referring now more particularly to the drawings, there is shown a steering column 10 for an automotive vehicle. As best seen in FIGS. 1 and 13, the steering column 10 includes an outer jacket 12, an outer cylinder 14, an inner cylinder 15, a telescope assembly, a tilt assembly and three electric motors 32, 34 and 36 for controlling the tilt and telescope functions.

As best seen in FIGS. 1 and 13, the outer cylinder (tube) 14 and the inner cylinder (tube) 15 are cylindrically shaped tubes. The outer cylinder 14 is concentric with the inner cylinder 15.

The inner and outer cylinders 15, 14 are coupled together via a slider 46. The slider 46 is positioned between the inner cylinder 15 and the outer cylinder 14 so as to permit a telescoping motion between the inner and outer cylinders 15, 14. More specifically, the inner cylinder 15 is axially slidably telescoped in the outer cylinder 14. The use of sliders is common in the automotive industry, and the slider 46 may be coupled to the inner and outer cylinders 15, 14 using techniques known to one of ordinary skill in the art. The slider 46 may be constructed of a plastic material or other material that permits the inner and outer cylinders 15, 14 to achieve the telescoping motion.

Additionally, a steering shaft 30 extending lengthwise along the axis of the inner cylinder 15 may be located within the inner and outer cylinders 15, 14. The steering shaft 30 may be coupled at one end to the outer cylinder 14 via a bearing 42 and at the opposite end to a bearing 48, as best seen in FIG. 13. The steering shaft 30 may be rotatably mounted in the inner and outer cylinders 15, 14 in a manner so as to be able to move axially and pivotally with respect to the inner and outer cylinders 15, 14. Such an arrangement permits the steering column 10 to pivot up or down and to be telescoped in or out as desired.

The steering shaft 30 may support a steering wheel (not shown) on one end. Such a steering wheel may be mounted to the steering shaft 30 using techniques known to one of ordinary skill in the art.

The steering shaft 30 may be constructed to have first (upper) and second (lower) sections 50, 52. The first and second sections 50, 52 may be joined together using a steering shaft slider 54, as best seen in FIG. 13. The steering shaft slider 54 may permit a telescoping type action between the first and second sections 50, 52.

Referring back to FIG. 1, the steering column 10 may also include an outer jacket 12, wherein the outer jacket 12 may form a housing surrounding the inner and outer cylinders 15, 14. The outer jacket 12 may form part of a tilt and telescope assembly of the steering column 10.

As best seen in FIGS. 1 and 13, the outer jacket 12 may include a top surface 11 and opposing sidewall surfaces 16, with the opposing sidewall surfaces 16 having slotted openings 20. In the embodiment shown in FIG. 1, the outer jacket 12 may be slotted vertically to permit tilt functions.

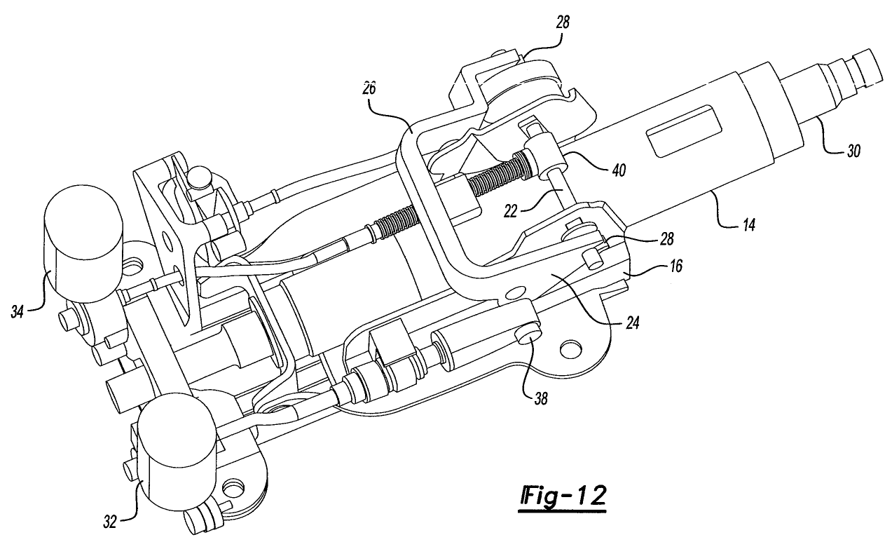

As best seen in FIGS. 1, 12 and 13, the steering column 10 may also include an anchorage 24, wherein the anchorage 24 may form part of the tilt and telescoping assemblies. The anchorage 24 may include a U-shaped bracket 26 defining opposing sidewall surfaces, and the opposing sidewall surfaces, in turn, may define U-shaped slots 28, as best seen in FIG. 12. The anchorage 24 may also support outwardly projecting lugs 38, as best seen in FIGS. 1 and 13. In an embodiment of the steering column 30, the anchorage 24 may be assembled as part of the steering column 10 so as to permit axial and pivot-type movement relative to the steering shaft 30.

Now referring to FIG. 13, the steering column 10 may also include a compression bracket 56, which forms part of the telescope assembly. As best seen in FIG. 1, the compression bracket 56 may define slots 44. In the embodiment shown herein, the slots 44 may be positioned horizontally in the compression bracket 56 so as to permit telescoping type movement in the cylinders 15, 14. The compression bracket 56 may be constructed of a metal material and may be welded onto the outer cylinder 14.

Furthermore, as best seen in FIG. 13, the steering column 10 may also include a tilt pivot 58. The tilt pivot 58 defines the axis along which the steering column 10 tilts about. The tilt pivot 58 may also include a tilt bracket 60, which may be welded to the outer jacket 12. The tilt bracket 60 may also be coupled at the side surfaces of an upper mounting bracket 48. For example, rivets may be used to secure engagement between the tilt pivot 58 and the upper mounting bracket 48.

For illustrative purposes, the mechanical functioning of the tilt and telescope assemblies described in the illustrative embodiment is enabled by coupling the compression bracket 56, the anchorage 24 and the outer jacket 12 as best seen in FIGS. 1 and 12. The compression bracket 56, anchorage 24 and the outer jacket 12 are coupled together via a cross-bolt 22. The cross-bolt 22 may be inserted through the slots 44 defined by the compression bracket 56, the slots 20 formed in the outer jacket 12 and the U-shaped slots 28 in opposing sidewalls of the anchorage 24. Such coupling permits the cross-bolt 22 to slide along the length of the slots 20 formed in the outer jacket 12 and to slide axially along the slots 44 formed in the compression bracket 56. As will be described below, the cross-bolt 22 may be put under tension by a locking motor 36 to secure the steering column 10 in the desired tilt-telescope position.

The tilt-telescope functions permitted by the mechanical assembly of the compression bracket 56, the anchorage 24 and the outer jacket 12, may be actuated electrically. For example, in the illustrative embodiment described herein, the tilt and telescope positions of the steering column 10 may be adjusted through a switch or a memory function, where such adjustments may be actuated by electric motors 32, 34 and 36 as described below.

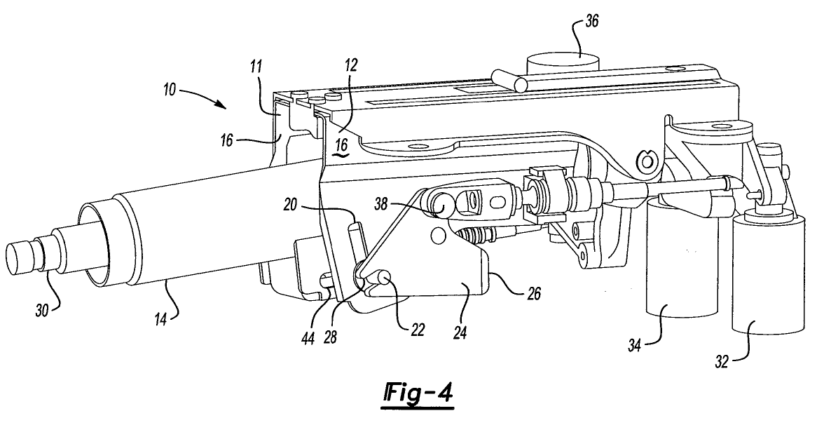

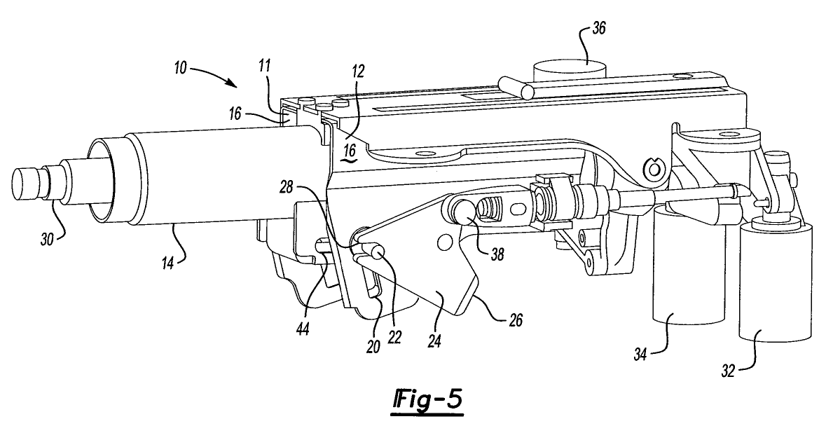

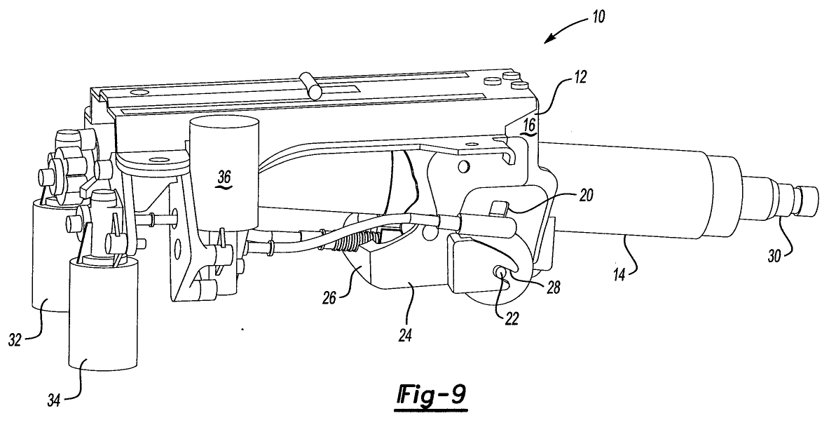

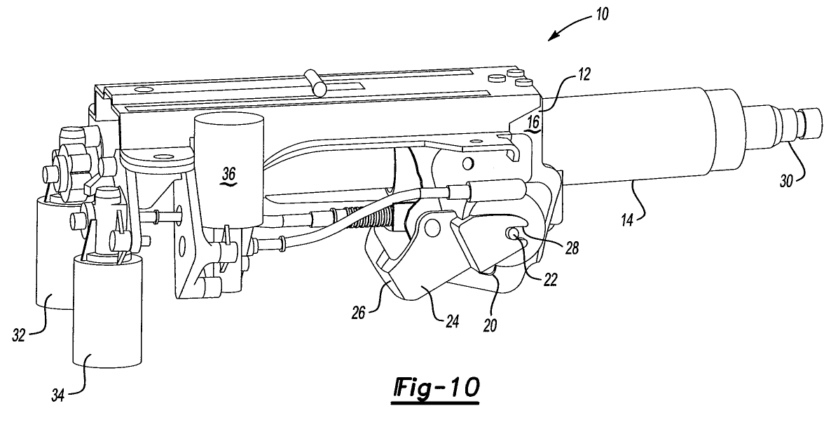

As illustrated in FIG. 12, the outwardly projecting lugs 38 of the anchorage 24 may support a connection between electrical motors 32, 34. Specifically, the outwardly projecting lugs 38 may be connected to the tilt motor 32. In one embodiment, the tilt motor 32 is used to tilt the U-shaped bracket 26 either up or down, as best seen in FIGS. 4-5, 9-10. Preferably, the tilt range is ±4 degrees from the nominal position. The locking motor 36 may be used to unlock the steering column 10 prior to adjustment of the tilt-telescope position of the steering column 10 and to lock the steering column 10 in position following such an adjustment.

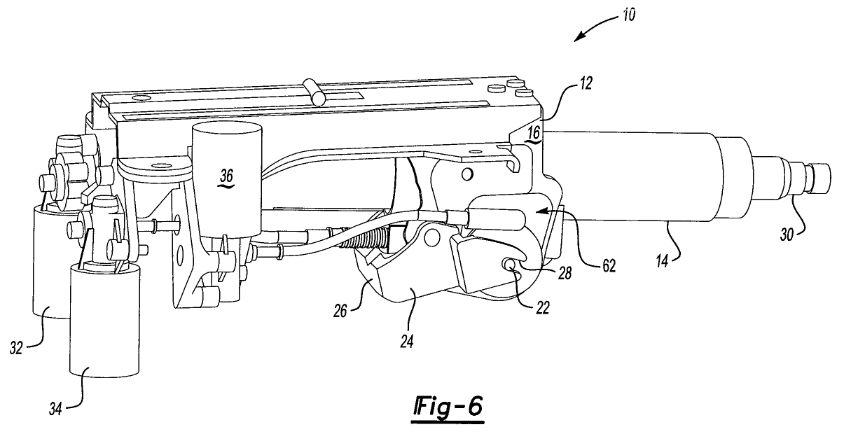

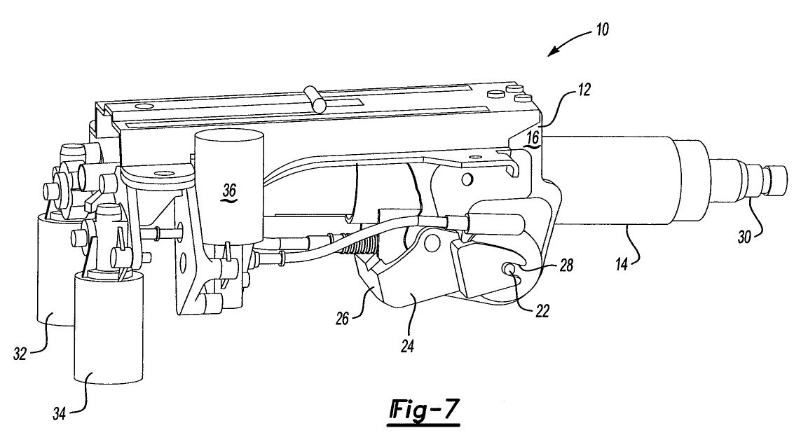

The locking motor 36 may be used to rotate a flex cable attached to a lock housing 62 as shown in FIGS. 6 and 7. The lock housing may house a rotary cam that is driven by a worm gear attached to an end of the flex cable. Such a cam, when rotated, may deflect the translating bracket 12 so as to compress the translating bracket 12 upon the compression bracket 56 to lock the steering column 10 and to prevent any tilting or telescoping of the steering column 10.

The telescope function of the steering column 10 may be best described with reference to FIG. 12. As shown in FIG. 12, a telescope mechanism 40 may be coupled to the telescope motor 34, which may be an electrical motor. When the telescope motor 34 is appropriately energized, the telescope mechanism 40 may react against the cross-bolt 22 to telescope the outer cylinder 14 and the upper section 50 of the steering shaft 30 along the axis of the steering column 10. Preferably, the steering column 10 may be telescoped up to a range of ±25 millimeters from the nominal position of the steering column 10.

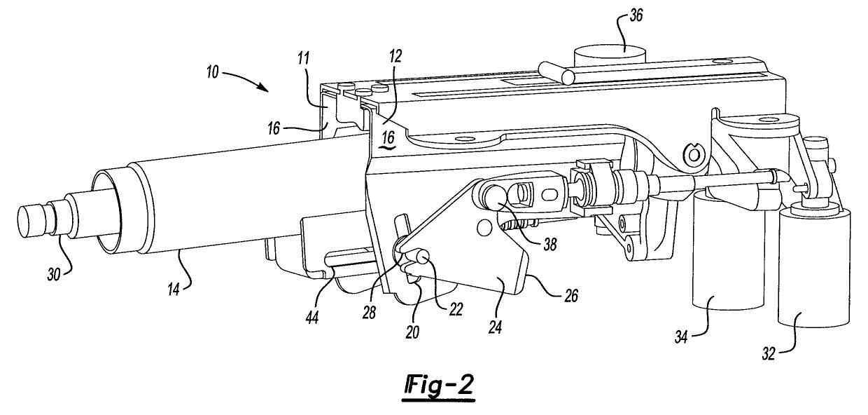

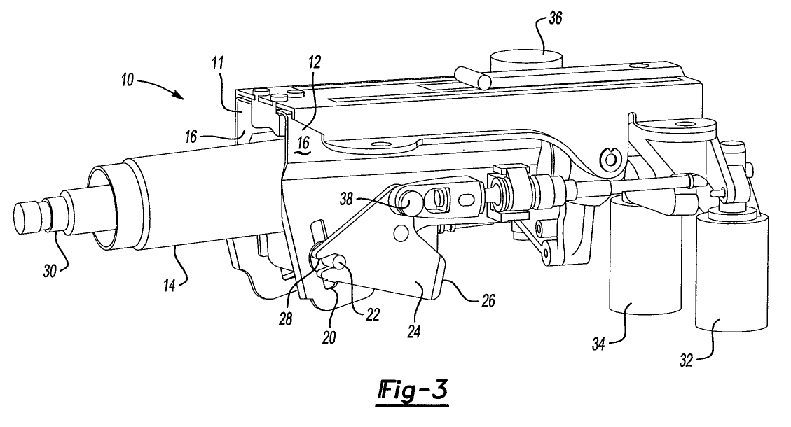

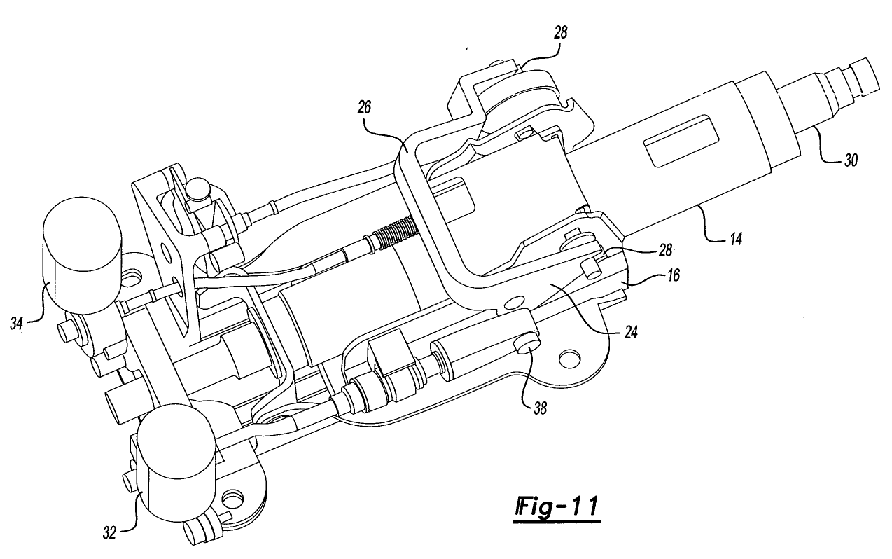

The pivot (tilt) movement of steering column 10 is best illustrated in FIGS. 1-5, 11-13. As best seen in FIGS. 1, 12 and 13, the outer jacket 12 is coupled to an anchorage 24 by a cross-bolt 22. As shown in FIG. 12, the anchorage 24 includes a U-shaped bracket 26 that defines U-shaped slots 28 in opposing sidewalls, as best seen in FIG. 12. To assemble the outer jacket 12 and the anchorage 24, the U-shaped slots 28 of the anchorage 24 are positioned over the slotted openings 20 of the outer jacket 12. As shown in FIG. 12, the cross-bolt 22 may be inserted through the slotted openings 20 and the U-shaped slots 28. Furthermore, as best seen in FIG. 12, the U-shaped bracket 26 may also support outwardly projecting lugs 38, which, as described above, may be placed on opposite sides of the anchorage 24.

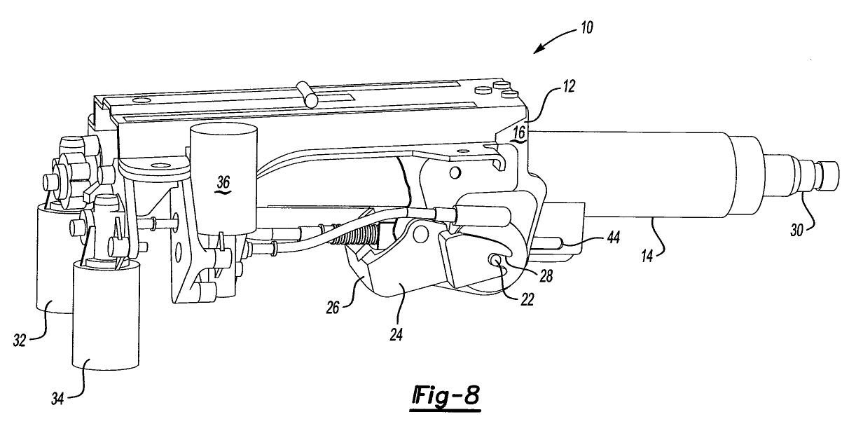

The above description provides an overview of the tilt and telescope functions of the steering column 10. The drawings, FIGS. 1-13, provide a more detailed description of the tilt and telescope features of the steering column 10. Together, the written description and the drawings teach the novel features of the steering column 10.

A person of ordinary skill in the art would realize, however, that certain modifications would come within the teachings of this patent. In view of the many possible embodiments to which the principles of this patent may be applied, it should be recognized that the embodiments described herein with respect to the drawings figures are meant to be illustrative only and should not be taken as limiting the scope of patent. Therefore, the steering column apparatus as described herein contemplates all such embodiments as may come within the scope of the following claims and equivalents thereof.

What is claimed is:

1. A steering column apparatus comprising:
an outer cylinder positioned along a telescopic axis of the steering column apparatus;
an inner cylinder axially located within the outer cylinder;
a steering shaft located within the inner cylinder;
an outer jacket housing the inner and the outer cylinders, the outer jacket including outer jacket sidewall surfaces having slotted openings;
an anchorage located along the outer jacket sidewall surfaces, the anchorage having brackets having tilt slots perpendicular to the telescopic axis of the steering column apparatus;
a compression bracket attached to the outer jacket, the compression bracket having telescopic slots aligned with the telescopic axis of the steering column apparatus; and
a cross-bolt adapted to couple together the outer jacket, the anchorage and the compression bracket using the outer jacket slotted openings, the anchorage tilt slots and the compression bracket telescopic slots.

2. The steering column apparatus of claim 1, further comprising a locking motor adapted to secure the steering column apparatus in a tilt-telescope position.

3. The steering column apparatus of claim 1, wherein the anchorage is attached to a tilt-motor adapted to tilt the steering shaft along a pivotal axis.

4. The steering column apparatus of claim 1, wherein the cross-bolt is attached to a telescopic motor via a telescope mechanism in a manner so as to move the steering shaft along the telescopic axis in response to a signal from the telescopic motor.

5. The steering column apparatus of claim 1, wherein the steering shaft is attached to a steering wheel of an automobile.

6. The steering column apparatus of claim 1, wherein the steering shaft is coupled to the outer cylinder via a bearing.

7. The steering column apparatus of claim 1, wherein the steering shaft further comprises;
a first section;
a second section; and
a steering shaft slider joining the first section and the second section, wherein the steering shaft slider permits a movement between the first section and the second section along the telescopic axis.

8. The steering column apparatus of claim 1, wherein the steering shaft is adapted to tilt within a range of ±4 degrees from a nominal tilt position.

9. The steering column apparatus of claim 1, wherein the steering shaft is adapted to telescope within a range of ±25 millimeters from a nominal telescope position.

10. The steering column apparatus of claim 2, wherein the locking motor is adapted to be operated using at least one of a switch and a memory.

11. The steering column apparatus of claim 1, wherein the inner cylinder is capable of sliding axially within the outer cylinder.

12. The steering column apparatus of claim 2, further comprising:
a flex cable attached to the locking motor;
a cam driven by a worm gear attached to the flex cable, wherein the cam is adapted to compress a translating bracket upon the compression bracket; and
wherein the locking motor is further adapted to secure the steering column apparatus in a tilt-telescope position by rotating the flex cable to cause the translating bracket to compress upon the compression bracket to lock the steering column apparatus.

13. A steering column apparatus comprising:
a cylinder assembly having an inner cylinder and an outer cylinder positioned along a telescopic axis of the steering column apparatus;
a steering shaft located within the cylinder assembly;
an outer jacket housing the cylinder assembly, the outer jacket including sidewall surfaces having slotted openings;
an anchorage located along the sidewall surfaces, the anchorage having brackets having tilt slots perpendicular to the telescopic axis;
a compression bracket attached to the outer jacket, the compression bracket having telescopic slots aligned with the telescopic axis; and
a cross-bolt adapted to couple together the outer jacket, the anchorage and the compression bracket using the outer jacket slotted openings, the anchorage tilt slots and the compression bracket telescopic slots, the cross-bolt attached to a locking motor.

14. The steering column apparatus of claim 13, wherein the anchorage is attached to a tilt-motor adapted to tilt the steering column along a pivotal axis, and the cross-bolt is attached to a telescopic motor via a telescope mechanism in a manner so as to move the steering column along the telescopic axis in response to a signal from the telescopic motor.

15. The steering column apparatus of claim 14, wherein each of the locking motor, the tilt motor and the telescopic motor is operated using at least one of a switch and a memory.

16. The steering column apparatus of claim 14, wherein the steering shaft is attached to a steering wheel of an automobile.

17. The steering column apparatus of claim 14, wherein the locking motor is further adapted to unlock the steering assembly from a tilt-telescope position before activating any of the tilt-motor and the telescopic motor.

18. A method of controlling tilt-telescope positions of a steering column apparatus, the apparatus comprising a steering shaft located within an inner and outer cylinder assembly, a tilt-motor, a telescopic motor and a locking motor, the method comprising:
receiving an unlock signal at the locking motor;
in response to the unlock signal, providing an energizing signal to an outer jacket housing the inner and outer cylinder assembly to unlock the inner and outer cylinder assembly from the outer jacket;
receiving a telescope signal at the telescope motor;
in response to the telescope signal, providing an energizing signal to a cross-bolt attached to a compression jacket to telescope the steering shaft along a telescopic axis of the steering column apparatus;
receiving a tilt signal at the tilt-motor; and
in response to the tilt signal, providing an energizing signal to an anchorage located along the outer jacket to tilt the steering column apparatus along a tilt-axis.

19. The method of claim 18, wherein each of the locking motor, the telescope motor and the tilt-motor receives the unlock signal, the telescope signal and the tilt-signal, respectively, by an automated switch.

20. The method of claim 18, further comprising:
receiving a lock signal at the locking motor; and
in response to the lock signal, rotating a flex cable to cause a translating bracket to compress upon a compression bracket to lock the steering column apparatus.
